(19) United States
(12) Patent Application Publication
(10) Pub. No.: US 2013/0203611 A1
(43) Pub. Date: Aug. 8, 2013

(54) AUTOMATIC SLIDE LOADING DEVICE FOR MICRO ARRAY SCANNER AND ITS METHODS OF USE

(71) Applicants: Hang Li, Beijing (CN); Huihui Teng, Beijing (CN); Danyang Mei, Beijing (CN); Wenjun Wang, Beijing (CN); Gang Li, Beijing (CN); Xiaokun Qin, Beijing (CN); Zhengde Feng, Beijing (CN); Dong Wang, Beijing (CN); Jing Cheng, Beijing (CN)

(72) Inventors: Hang Li, Beijing (CN); Huihui Teng, Beijing (CN); Danyang Mei, Beijing (CN); Wenjun Wang, Beijing (CN); Gang Li, Beijing (CN); Xiaokun Qin, Beijing (CN); Zhengde Feng, Beijing (CN); Dong Wang, Beijing (CN); Jing Cheng, Beijing (CN)

(73) Assignees: Tsinghua University, Beijing (CN); CapitalBio Corporation, Beijing (CN)

(21) Appl. No.: 13/814,196

(22) PCT Filed: Aug. 5, 2011
(86) PCT No.: PCT/CN2011/001287

§ 371 Date: Apr. 15, 2013

(30) Foreign Application Priority Data
Aug. 6, 2010 (CN) 201010247280.8

(51) Int. Cl. G01N 21/64; B25J 11/00

(52) U.S. Cl. CPC G01N 21/6486; B25J 11/00
USPC 506/7; 414/225.01; 422/563; 422/565; 506/39

(57) ABSTRACT

An automatic slide loading device for microarray scanner comprises slide holders (1), a carrier device (2) and a positioning chamber (3), wherein the slide holder (1) can hold microarray slides (6) and the slide holder (1) is placed out of the scanning platform of the microarray scanner when the microarray scanner is in off work state, wherein the carrier device (2) is connected to the positioning chamber (3) and the carrier device (2) can load the slide holder (1) into the positioning chamber (3), wherein the positioning chamber (3) is placed above the scanning platform of the microarray scanner and is used to precisely locate the working surface of the microarray slides (6) in the slide holder (1).

### TECHNICAL FIELD

This application is in the field of an automatic loading device of slides, particularly in the field of an automatic loading device for a microarray scanner.

### BACKGROUND ART

In the initial development of microarray technology, messenger RNA isolated from biological samples, including cells, etc., is transcribed into cDNA, labeled with fluorophores, and used to hybridize with the microarray which carries typically tens of thousands oligonucleotide probes. The complementary sequences of the oligonucleotide probe and cDNA hybridize with each other, thus fluorescent signal can be detected and the signal intensity is in proportion to the abundance of mRNA expression. The usage of microarray technology is analogized to biological micro processor and empowers rapid and quantitative analysis of gene expression profile, pathological genotype, drug metabolism, genetics and development of diseases on the genomic scale. The detection technology of microarray is developed along with the development of the microarray technology. One component of microarray detection technology is the microarray scanner, which integrates optical, mechanical and electronic technologies to detect the experimental result of fluorophore-labeled microarrays.

A typical microarray scanner consists of a microarray slide loading device, an excitation source(s), optical lenses, a light detector(s) and a scanning movement platform. The loading device places the microarray slide to the focusing plane of the optical lens. The fluorescent probes absorb the exaltation light from light source and emit fluorescence. The fluorescence is collected by the optical lens and sent to the detector. The detector captures fluorescence from a tiny area of the slide surfaces each time, and the scanning movement platform performs two-dimensional movements at a high speed to do two-dimensional scanning of the slides. The fluorescent signals from each area are captured and recorded until the whole slide is scanned to acquire complete information of the microarray.

There are several commercial microarray scanners which can load slides automatically but the loading devices are complex and expensive. Some frequently damage microarray slides when loading or scanning. The loading device disclosed in U.S. Pat. No. 4,159,875 has two cassettes to store the slides, one for slides to be scanned and the other for slides already scanned. The device is bulky whereas the slides can only be taken out or put back in order. The structure of the cassettes is complex, and the barcodes are on the cassettes while barcodes are usually on the slides in most commercially available products. Some microscopic instruments involve automatic slide loading devices also. For instance, U.S. Pat. No. 6,847,481 discloses an automatic microscopic slide loading frame comprising three parts: two slide frames, XY movement platform, and an arm which can pick slides from one frame to the operating platform of the microscope to be observed and then unload them to another frame. The device can automatically load and unload the slides but the slides are exposed to the environment and subject to contaminations and damages. The device is suitable for microscope, and relies on the focus adjusting mechanism on the microscope to get clear images. It ignores the precise locating of the slide surface thus does not apply to the automatic loading of microarray slides.

### SUMMARY OF THE INVENTION

In one aspect, provided herein is a slide holder comprising four surrounding protuberances to form a frame, wherein the heights of two substantially parallel protuberances (the 1^{st} protuberance and the 2^{nd} protuberance) are less than the thickness of the slide, each of the other two substantially parallel protuberances (the 3^{rd} protuberance and 4^{th} protuberance) comprises at least one hook, and the height of the hook is greater than the thickness of the slide.

In some embodiments, the slide holder may further comprise an elastic rubber column. In some embodiments, the working range of the elastic rubber column may be greater than the length of the hook. In some embodiments, the elastic rubber column may comprise a body of an H-shaped cylinder, the thinner part in the middle may be used to install the elastic rubber column on the slide holder, and may further comprise a cylindrical recess on the upper side. In some embodiments, the 4^{th} protuberance may comprise a U-shaped opening. In some embodiments, the 3^{rd} protuberance may comprise an adaptor. In some embodiments, the slide holder may further comprise a relief on one side. In some embodiments, the slide holder may further comprise a chamfer on one edge between the side and the bottom of the slide holder. In some embodiments, the slide holder may further comprise a dark material that has a low auto-fluorescence level. In some embodiments, the height of the hook may be between about 110% and 140% of the thickness of the slide. In some embodiments, the shape of the frame of the slide holder may be the same as the shape of the slide, which may be a rectangle, square, circle, or any other shape.

Also provided herein is a carrier device comprising a rod, a slide block which connects to one end of the threaded rod, and a motor which drives the rod horizontally, wherein a gap may exist between the rod and the slide block. In some embodiments, the rod may be elastic. In some embodiments, the carrier device may further comprise a round finger adaptor fixed on one end of the rod.

Further provided herein is a positioning chamber comprising an installation seat with a cross section of U-shape, two alignment pieces symmetrically installed on the bottom of the positioning chamber, an elastic pressing sheet component in the installation seat, wherein the elastic pressing sheet component may comprise one or more trolleys and a connector sheet, and each trolley is connected to the connector sheet. In some embodiments, the positioning chamber may further comprise one or more elastic sheets, springs, and screws, wherein the trolley is connected to the connector sheet via the elastic sheet, and the connector sheet is installed on the installation seat with the springs and screws. In some embodiments, the positioning chamber may further comprise one or more pairs of lateral pressing guide sheets which are on the side of the installation seat, wherein one end of the lateral pressing guide sheet is fixed on the front end of the installation seat and the other end extends into the interior space of the installation seat, and wherein the lateral pressing guide sheet may be made of an elastic material.

Still further provided herein is an automatic slide loading device, which comprises one or more slide holders, and a carrier device. In some embodiments, the slide holder and the carrier device may each comprise an adaptor, and the shape and dimension of the adaptor of the carrier device may be complementary to the shape and dimension of the adaptor of the slide holder. In some embodiments, the adaptor of the carrier device and/or the adaptor of the slide holder may comprise a rounding chamfer on the edge. In some embodiments, the adaptor of the carrier device and the adaptor of the slide holder may comprise one female end and one male end, wherein the female or male end may be part of, or a standalone unit connected to, the rod of the carrier device, and wherein the male or female end may be part of, or a stand-alone unit connected to, the slide holder. In some embodiments, the shape of the adaptor of the carrier device and/or the adaptor of the slide holder may be circular, diamond, or other geometrical forms. In some embodiments, the automatic slide loading device may further comprise a positioning chamber. In some embodiments, the carrier device may be mounted on the rear part of the positioning chamber. In some embodiments, the elastic pressing sheet component in the installation seat of the positioning chamber may press the slide holder tightly and may locate the slide holder precisely.

In some embodiments, the automatic slide loading device may further comprise one or more magazines which comprise the slide holders therein. In some embodiments, each magazine may comprise one or more compartments to accommodate the one or more slide holders in a vertical arrangement, the slide holders can be taken out or returned back to the magazine horizontally, the compartments are separated by guide rails which guide and restrict the horizontal movement of the slide holders into the magazine, the guide rail matches to the chamfer on the slide holder, wherein one or more positioning beads are installed inside the side wall of the magazine, and wherein there are openings on the back board of the magazine. In some embodiments, each slide holder may comprise a relief that matches the positioning bead inside the side wall of the magazine. In some embodiments, the automatic slide loading device may further comprise one or more sensors on the side of the positioning chamber, wherein the sensors face the magazine, wherein the sensor may be a photoelectric sensor.

In some embodiments, the automatic slide loading device may further comprise a random access device. In some embodiments, the random access device may comprise a motor, a threaded rod, a guide rail, an assembly support, a bracket and a positioning seat, the step motor and the guide rail are mounted onto the positioning seat, wherein the motor drives the rotation of the threaded rod. In some embodiments, the random access device may be connected to the magazine or the carrier device through the bracket of the random access device. In some embodiments, the random access device may further comprise a position detection marker connected to the bracket, wherein the position detection marker may be of the same height as the magazine, the position detection marker may comprise an opening corresponding to each compartment in the magazine. In some embodiments, the random access device may further comprise at least two sensors on the positioning seat of the random access device, wherein one of the sensors may be used as a closed loop feedback control, and the rest of the sensors are used to define the end positions and/or the range of the magazine movement.

Additionally provided herein is an automatic slide scanning device comprising an automatic slide loading device and a scanner which comprises a scanning platform. In some embodiments, the adaptor of the carrier device aligns to the adaptor of a pre-determined slide holder. In some embodiments, the positioning chamber may further comprise one or more fine tuning threaded rods. In some embodiments, the positioning seat of the random access device may be fixed to the scanner via the assembly support of the random access device.

In another aspect, the present invention provides a method of scanning a slide using an automatic slide scanning device. In some embodiments, the positioning chamber may be placed above the scanning platform of the scanner and may be used to locate the working surface of the slide. In some embodiments, the carrier device loads the slide holder into the positioning chamber. In some embodiments, the positioning chamber may comprise one or more fine tuning threaded rods to adjust the alignment pieces of the positioning chamber according to the plane of movement of the scanning platform of the scanner. In some embodiments, the scanner may adjust the position of the slide for scanning. In some embodiments, the carrier device may take the slide holder from the magazine for scanning and returns the slide holder to the magazine after scanning. In some embodiments, the automatic slide scanning device may comprise a random access device, which drives the relative vertical movement between the magazine and the carrier device, and moves a pre-determined slide holder to the position of the carrier device, wherein the motor of the random access device moves the bracket of the random access device vertically. In some embodiments, the adaptor of the carrier device may pull a pre-determined slide holder out of the magazine horizontally and into the positioning chamber to be scanned by the scanner. In some embodiments, the slide holder may be placed out of the scanning platform of the scanner when the slide is not being scanned. In some embodiments, the slide holder may comprise a microarray slide for scanning. In some embodiments, the microarray slide may be scanned within the slide holder.

### BRIEF DESCRIPTION OF THE DRAWINGS

FIG. 1 is a schematic diagram of an exemplary embodiment of the automatic slide loading device.

FIG. 2 is a schematic diagram of another exemplary embodiment of the automatic slide loading device.

FIG. 3 is a schematic diagram of an exemplary slide holder.

FIG. 4 is a cross section view of an exemplary elastic rubber column.

FIG. 5 is a schematic diagram of an exemplary carrier device.

FIG. 6 is a schematic diagram of an exemplary combination of the round female end on the carrier device and the round male end on the slide holder.

FIG. 7 is a schematic diagram of an exemplary combination of the square male end on the carrier device and the square female end on the slide holder.

FIG. 8 is a three-dimensional schematic diagram of an exemplary positioning chamber.

FIG. 9 is a sectional view of an exemplary positioning chamber.

FIG. 10 is a zoomed-in partial diagram of FIG. 9.

FIG. 11 is a schematic diagram of an exemplary elastic pressing sheet component on the positioning chamber.

FIG. 12 is a rear view of an exemplary magazine.

FIG. 13 is a side view of an exemplary random access device.

FIG. 14 is a rear view of an exemplary random access device.

### DETAILED DESCRIPTION OF THE INVENTION

This invention provides an automatic slide loading device for scanning and its methods of use.

### A. Definitions

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, the singular forms “a”, “an”, and “the” include plural references unless indicated otherwise. For example, “a” dimer includes one or more dimers.

As used herein, the term “substantially” means that the actual value is within about 10% of the actual desired value, particularly within about 5% of the actual desired value and especially within about 1% of the actual desired value of any variable, element or limit set forth herein. Accordingly, as used herein, the term “substantially parallel” refers to the angle between the two lines is from 0 to 45 degrees or from 135 to 180 degrees. It can be a smaller range, e.g., 0 to 30 degrees or 150 to 180 degrees, or 0 to 15 degrees or 165 to 180 degrees. Preferably, the two lines are completely parallel, i.e., the angle between the two lines is 0 or 180 degrees. The term “substantially free” varies with the context as understood by those skilled in the relevant art and generally means at least 70%, preferably means at least 80%, more preferably at least 90%, and most preferably at least 95% or 99% free, or completely free.

It is understood that aspects and embodiments of the invention described herein include “consisting” and/or “consisting essentially of” aspects and embodiments.

Other objects, advantages and features of the present invention will become apparent from the following specification taken in conjunction with the accompanying drawings.

### B. Automatic Slide Loading Device

The purpose of the invention is to provide an automatic slide loading device for microarray scanners and methods of use.

In one aspect, provided herein is a slide holder comprising four surrounding protuberances to form a frame, wherein the heights of two substantially parallel protuberances (the 1^{st} protuberance and the 2^{nd} protuberance) are less than the thickness of the slide, each of the other two substantially parallel protuberances (the 3^{rd} protuberance and 4^{th} protuberance) comprises at least one hook, and the height of the hook is greater than the thickness of the slide.

In some embodiments, the slide holder may further comprise an elastic rubber column. In some embodiments, the working range of the elastic rubber column may be greater than the length of the hook. As used herein, “working range of the elastic rubber column” refers to the difference in the size of the rubber column with and without pressure. In some embodiments, the elastic rubber column may comprise a body of an H-shaped cylinder, the thinner part in the middle may be used to install the elastic rubber column on the slide holder, and may further comprise a cylindrical recess on the upper side. In some embodiments, the 4^{th} protuberance may comprise a U-shaped opening. In some embodiments, the 3^{rd} protuberance may comprise an adaptor. In some embodiments, the slide holder may further comprise a relief on one side. In some embodiments, the slide holder may further comprise a chamfer on one edge between the side and the bottom of the slide holder. In some embodiments, the slide holder may further comprise a dark material that has low auto-fluorescence level. In some embodiments, the top layer and/or bottom layer may be about 2-10 mm in width. In some embodiments, the height of the hook may be between about 110% and 140% of the thickness of the slide. The slide holder may have a frame of any suitable shape or form. In some embodiments, the shape of the frame of the slide holder may be the same as the shape of the slide, which may be a rectangle, square, circle, or any other shape.

Also provided herein is a carrier device comprising a rod, a slide block which connects to one end of the rod, and a motor which drives the rod horizontally, wherein a gap may exist between the rod and the slide block. Any suitable motor may be used to drive the rod. For example, a liner motor may be used. In some embodiments, the rod may be elastic. In some embodiments, the carrier device may further comprise a round finger adaptor fixed on one end of the rod, which may be used to couple with the adaptor on the slide holder in order to move it. Any suitable configuration of the adaptors may be used. In some embodiments, there may be one female end and one male end for the pair of adaptors. The female or male ends can be part of the rod, or a stand-alone unit connected to the rod; and can be part of the slide holder, or a stand-alone unit connected to the slide holder. The shape of the end can be circular, diamond or other geometrical shapes.

Further provided herein is a positioning chamber comprising an installation seat with a cross section of U-shape, two alignment pieces symmetrically installed on the bottom of the positioning chamber, an elastic pressing sheet component in the installation seat, wherein the elastic pressing sheet component may comprise one or more trolleys and a connector sheet, and each trolley is connected to the connector sheet. In some embodiments, the positioning chamber may further comprise one or more elastic sheets, springs, and screws, wherein the trolley is connected to the connector sheet via the elastic sheet, and the connector sheet is installed on the installation seat with the springs and screws. In some embodiments, the positioning chamber may further comprise one or more pairs of lateral pressing guide sheets which are on the side of the installation seat, wherein one end of the lateral pressing guide sheet is fixed on the front end of the installation seat and the other end extends into the interior space of the installation seat, and wherein the lateral pressing guide sheet may be made of an elastic material.

Still further provided herein is an automatic slide loading device, which comprises one or more slide holders, and a carrier device. In some embodiments, the slide holder and the carrier device may each comprise an adaptor, and the shape and dimension of the adaptor of the carrier device may be complementary to the shape and dimension of the adaptor of the slide holder. In some embodiments, the adaptor of the carrier device and/or the adaptor of the slide holder may comprise a rounding chamfer on the edge. In some embodiments, the adaptor of the carrier device and the adaptor of the slide holder may comprise one female end and one male end, wherein the female or male end may be part of, or a stand-alone unit connected to, the rod of the carrier device, and wherein the male or female end may be part of, or a stand-alone unit connected to, the slide holder. In some embodiments, the shape of the adaptor of the carrier device and/or the adaptor of the slide holder may be circular, diamond, or other geometrical forms. In some embodiments, the automatic slide loading device may further comprise a positioning chamber. In some embodiments, the carrier device may be mounted on the rear part of the positioning chamber. In some embodiments, the elastic pressing sheet component in the installation seat of the positioning chamber may press the slide holder tightly and may locate the slide holder precisely.

In some embodiments, the automatic slide loading device may further comprise one or more magazines which comprise the slide holders therein. In some embodiments, each magazine may comprise one or more compartments to accommodate the one or more slide holders in a vertical arrangement, the slide holders can be taken out or returned back to the magazine horizontally, the compartments are separated by guide rails which guide and restrict the horizontal movement of the slide holders into the magazine, the guide rail matches to the chamfer on the slide holder, wherein one or more positioning beads are installed inside the side wall of the magazine, and wherein there are openings on the back board of the magazine. A magazine may have any suitable number of compartments for slide holders, e.g., at least 10, 20, 50, 100, 200, 500, 1000 or more compartments may be contained in a magazine. In some embodiments, each slide holder may comprise a recess that matches the positioning bead inside the side wall of the magazine. In some embodiments, the automatic slide loading device may further comprise one or more sensors on the side of the positioning chamber, wherein the sensors face the magazine. Any suitable sensor can be used. In one example, a photoelectric sensor may be used.

In some embodiments, the automatic slide loading device may further comprise a random access device. In some embodiments, the random access device may comprise a motor, a threaded rod, a guide rail, an assembly support, a bracket and a positioning seat, the motor and the guide rail are mounted onto the positioning seat, wherein the step motor drives the rotation of the threaded rod. In some embodiments, the random access device may be connected to the magazine or the carrier device through the bracket of the random access device. In some embodiments, the random access device may further comprise a position detection marker connected to the bracket, wherein the position detection marker may be of the same height as the magazine, the position detection marker may comprise an opening corresponding to each compartment in the magazine. In some embodiments, the random access device may further comprise at least two sensors on the positioning seat of the random access device, wherein one of the sensors may be used as a closed loop feedback control, and the rest of the sensors are used to define the end positions and/or the range of the magazine movement. Any suitable sensors can be used. In one example, photoelectric sensors may be used.

Additionally provided herein is an automatic slide scanning device comprising an automatic slide loading device and a scanner which comprises a scanning platform. In some embodiments, the adaptor of the carrier device aligns to the adaptor of a pre-determined slide holder. In some embodiments, the positioning chamber may further comprise one or more fine tuning threaded rods. In some embodiments, the positioning seat of the random access device may be fixed to the scanner via the assembly support of the random access device.

The exemplary automatic slide loading device disclosed herein may have one or more of the following advantages due to the above features:
(1) The device protects microarray slides from damage and contamination during loading and scanning.
(2) The U-shaped opening on the holder exposes the barcode on the microarray slide to facilitate manual loading but does not affect barcode reading by the microarray scanner.
(3) The two elastic devices on the hook of the slide holder can tightly hold the microarray slide even when the slide is up-side down and moving fast without falling out of the slide holder. In the meantime, as the working range of the elastic devices is greater than the length of the hook, the microarray slide can be easily inserted into or removed from the slide holder. The elasticity of the devices can effectively avoid or reduce vibration damages to the microarray slide during scanning.
(4) The magazine contains multiple guide rails to form independent compartments to accommodate slide holders. With the cooperation of the carrier device and the random access device, the slide holder can be selected from the compartment, scanned in a random way and returned to the same compartment or another vacant compartment. Extra storage places are no longer necessary to retrieve the scanned slides, thus the magazine can be more compact and flexible.
(5) The rod mechanism of the carrier device is simple and economical.
(6) The positioning chamber can contain elastic pressing sheet components to press the slide against the alignment pieces and locate the microarray precisely. The protuberances of the slide holder do not contact the alignment pieces. This mechanism eliminates or reduces the need to adjust the focus position during scanning, thus simplifies the structure and improves the scanning speed.

### C. Methods for Automatic Slide Scanning

In another aspect, the present invention provides a method of scanning a slide using an automatic slide scanning device. In some embodiments, the positioning chamber may be placed above the scanning platform of the scanner and may be used to locate the working surface of the slide. In some embodiments, the carrier device loads the slide holder into the positioning chamber. In some embodiments, the positioning chamber may comprise one or more fine tuning threaded rods to adjust the alignment pieces of the positioning chamber according to the plane of movement of the scanning platform of the scanner. In some embodiments, the scanner may adjust the position of the slide for scanning. In some embodiments, the carrier device may take the slide holder from the magazine for scanning and returns the slide holder to the magazine after scanning. In some embodiments, the automatic slide scanning device may comprise a random access device, which drives the relative vertical movement between the magazine and the carrier device, and moves a pre-determined slide holder to the position of the carrier device, wherein the motor of the random access device moves the bracket of the random access device vertically. In some embodiments, the adaptor of the carrier device may pull a pre-determined slide holder out of the magazine horizontally and into the positioning chamber to be scanned by the scanner. In some embodiments, the slide holder may be placed out of the scanning platform of the scanner when the slide is not being scanned. Any suitable slides may be scanned using the automatic loading device disclosed herein. In some embodiments, the slide holder may comprise a microarray slide for scanning. In some embodiments, the microarray slide may be scanned within the slide holder.

### EXAMPLES

The following examples are offered to illustrate but not to limit the invention.

### Example 1

### Automatic Slide Loading Device

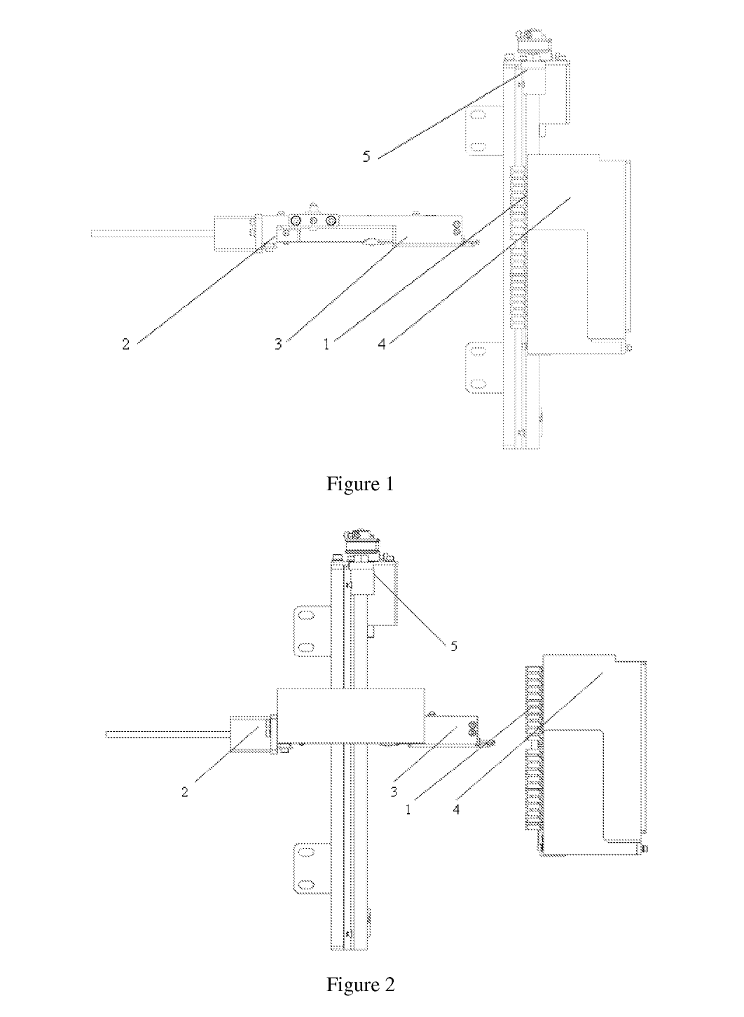

FIGS. 1 and 2 show an exemplary automatic slide loading device which consists of one or more slide holders 1 to accommodate one microarray slide each, one carrier device 2 to load and unload the slide holder 1, one magazine 4 to accommodate the slide holder 1, and one random access device 5 to select the specific slide holder 1 from the magazine 4. The slide holder 1 with microarray is inserted into the magazine 4. The random access device 5 can be connected to the magazine 4 via the bracket (FIG. 1), or be connected to the carrier device 2 (FIG. 2). The random access device 5 drives the relative vertical movement between magazine 4 and the carrier device 2, and move the selected slide holder 1 to the position of the carrier device 2, then the carrier device 2 take the slide holder 1 from the magazine 4, load it into the positioning chamber 3 which is connected to the scanning platform of the microarray scanner, and the scanner adjusts the relative position precisely and scan the microarray slide within the holder 1.

In the exemplary automatic slide loading device, for single slide microarray scanners, there can be only one magazine 4, or there can be no magazine 4 and the slide holder 1 is directly loaded to the scanning platform; for high throughput microarray slide scanners, there can be one or more magazine 4, and each magazine 4 can accommodate multiple slide holders 1.

### Example 2

### Slide Holder

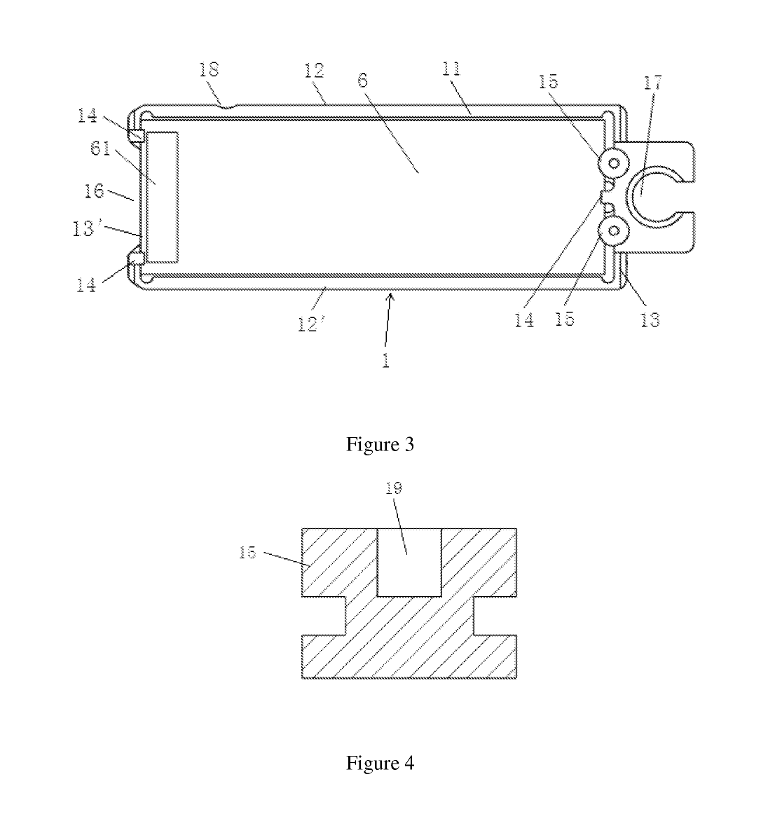

FIG. 3 shows an exemplary slide holder 1 consists of a frame 11 with four sides of protuberances on the bottom base, and the microarray slide 6 can be put into the frame 11. The first protuberance 12 and the second protuberance 12′ are substantially parallel on the frame 11, and their heights are less than the thickness of microarray slide 6. The third protuberance 13 and the fourth protuberance 13′ are also substantially parallel on the frame 11, and there is at least one hook 14 on them respectively, and the height of the hook is between 110% and 140% of the thickness of the microarray slide 6. There are two elastic rubber columns 15 substantially symmetrically installed on the hook 14 of the third protuberance 13 of the slide holder 1, to press the microarray slide 6 tightly and ensure that the microarray slide 6 does not fall out of the slide holder 1 even if slide holder 1 with the microarray slide 6 is up-side-down or is moving fast. The working range of the elastic rubber column 15 is greater than the length of the hook 14, thus the microarray slide 6 can be easily inserted into or removed from the slide holder 1, and the elasticity is adequate to avoid vibration damage to the microarray slide 6 during scanning. There is a U-shaped opening 16 no narrower than the thumb finger on the fourth protuberance 13′ but not on the third protuberance 13 of the slide holder 1, to facilitate the insertion and removal of the microarray slide 6 and do not affect the reading operation of the barcode 61 on the microarray slide 6 by the scanner.

In the exemplary slide holder, there is a C-shaped adaptor 17 on the third protuberance 13 of the slide holder 1. In the exemplary slide holder, there is a relief 18 on the side of the slide holder 1 to locate the slide holder 1 inside the magazine 4. In the exemplary slide holder, there is a chamfer on one edge between the side and the bottom of the slide holder 1 to avoid reverse insertion of the slide holder 1 into the magazine 4.

In the exemplary slide holder, there is dark material that has low auto-fluorescence level on the surface of the slide holder 1 to avoid stray light. In the exemplary slide holder, the shape of the frame 11 is determined by the shape of the microarray slide 6. It is usually a rectangle, but can also be any other shapes according to the shape of the microarray slide 6.

In the exemplary slide holder, the elastic rubber column 15 is a cylinder with a H-shaped section view as FIG. 4 shows. The thinner part in the middle is of the same diameter and thickness with the hole (not shown in FIG. 4) on the hook to install the elastic device. When the column is inserted into the hole, the thicker parts on both sides will clamp the slide holder 1. The mechanism is reliable and economic, and it is easy to assemble the elastic rubber column 15. There is a cylindrical recess 19 on the upper side of the elastic rubber column 15 to increase the elasticity and fit to microarrays slide 6 of different sizes.

### Example 3

### Carrier Device

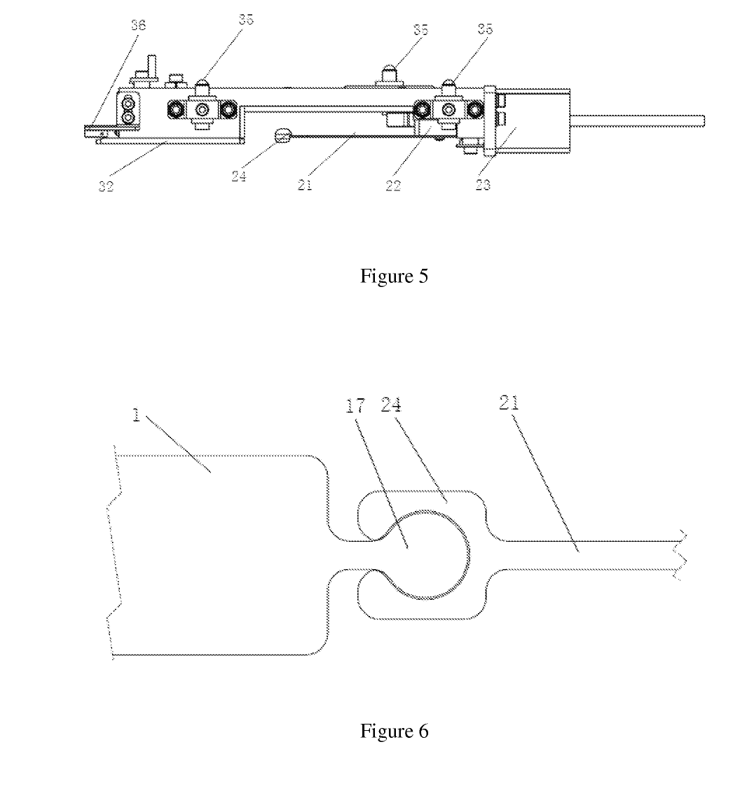

The exemplary carrier device 2 automatically fetches the slide holder 1 with microarray slide 6 from the magazine 4 into the positioning chamber 3 for scanning, and returns it back to the magazine 4. FIG. 5 shows that the exemplary carrier device 2 consists of a rod 21, a slide block 22 which connects one end of the rod 21 and a linear motor 23, a linear motor 23 mounted on the rear part of the positioning chamber 3. The linear motor 23 drives the rod 21 horizontally. There is a gap between the rod 21 and the slide block 22, and the threaded rod 21 is elastic. There is a round finger adaptor 24 fixed on one end of the rod 21. The shape and dimension of the adaptor 24 is matched with the adaptor 17 on the slide holder 1. When the magazine 4 moves up and down, the finger adaptor 24 can align to any of the adaptors 17 on slide holders 1, and pull the selected slide holder 1 out of the magazine 4 horizontally and into the positioning chamber 3 to be precisely located, scanned and out of the positioning chamber 3 and back into the magazine 4 again, thus implement the loading and unloading actions of the slide holder 1. There are rounding chamfers on the edge of the finger adaptor 24 and the adaptor 17 to tolerate an imperfect alignment between the adaptors.

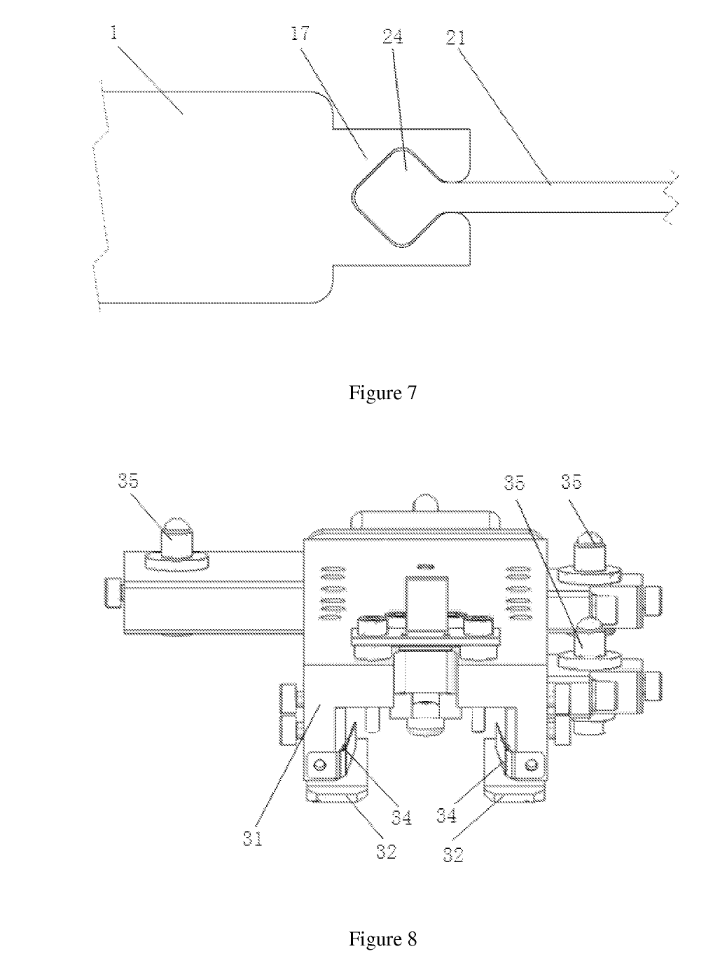

In some embodiments, there is one female end and one male end for the pair of finger adaptor 24 on the rod and the adaptor 17 on the slide holder. The female or male end can be part of the rod 21, or a stand-alone unit connected to the rod 21; and can be part of the slide holder 1, or a stand-alone unit connected to the slide holder 1. In the top view, the male end consists of a narrower “neck” which is near the rod 21 or the slide holder 1 and a wider “head” which is far from the rod 21 or the slide holder 1. The female end consists of complementary relief to the male end. The shape of the ends of the finger adaptor 24 and the adaptor 17 can be circular, diamond or any other geometrical form (FIGS. 6 and 7).

### Example 4

### Positioning Chamber

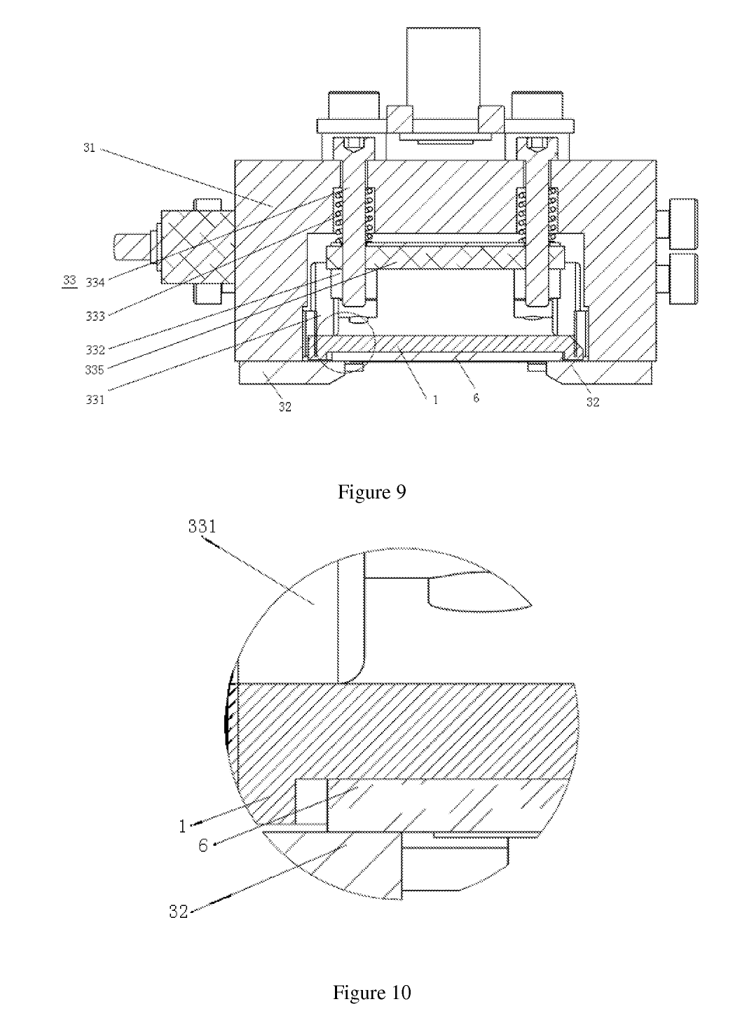

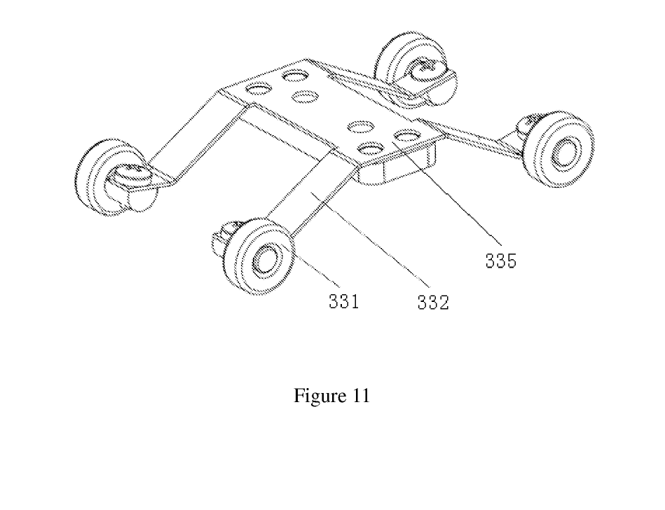

FIGS. 8-11 show an exemplary positioning chamber 3, which is fixed above the scanning platform (not shown in the figures) of the scanner, consists of an installation seat 31 with a U-shaped cross section. There are two alignment pieces 32 symmetrically installed on the bottom of the positioning chamber 31. There is an elastic pressing sheet component 33 in the installation seat 31 to press the slide holder 1 tightly and precisely locate the working surface of the microarray slide 6 to be scanned, while the protuberance 12 and 12′ do not contact the alignment pieces 32. The elastic pressing sheet component consists of several trolleys 331, elastic sheets 332, springs 333, screws 334 and a connector sheet 335.

In one exemplary embodiment, each of the four trolleys 331 is connected to the connector sheet 335 via an elastic sheet 332, and the connector sheet 335 is installed on the installation seat 31 with the springs 333 and screws 334. The arrangement is not limited to the above embodiment. The screws 334 may be fastened or loosened to move the elastic pressing sheet components relative to the installation seat 31 and change the deformation level of the springs 333 and elastic sheets 332, thus change the fitness of the elastic pressing sheet components to the slide holder 1. When loading or unloading the slide holder 1, trolleys 331 can reduce frictions and make the process more smoothly. The positioning chamber 3 also consists of a pair or several pairs of lateral pressing guide sheets 34 which are installed symmetrically on the side of the installation seat 31. The lateral pressing guide sheet 34 is made of elastic material. One end of the lateral pressing guide sheet 34 is fixed on the front end of the installation seat 31, and the other end extends into the interior space of the installation seat 31, so the lateral pressing guide sheet can precisely guide the slide holder 1 into or out of the central position of the positioning chamber 3.

In some embodiments, there are three fine tuning threaded rods 35 on the positioning chamber 3. The fine tuning threaded rods 35 may be fastened or loosened to ensure the alignment pieces are parallel to the plane of the scanning movement of the platform and perpendicular to the optical axis of the objective lens, thus ensure when the working surface of the microarray slide 6 is fitted onto the alignment pieces, the scanner can use only one position on the microarray as reference to find the proper focus position and all positions on the working surface of the microarray slide 6 will be on the focusing plane of the objective lens.

In some embodiments, there is a photoelectric sensor 36 on the side of positioning chamber 3. The sensor 36 faces the magazine 4 to detect whether there is a slide holder 1 in the specific, aligned compartment of the magazine 4 (FIG. 5).

### Example 5

### Magazine

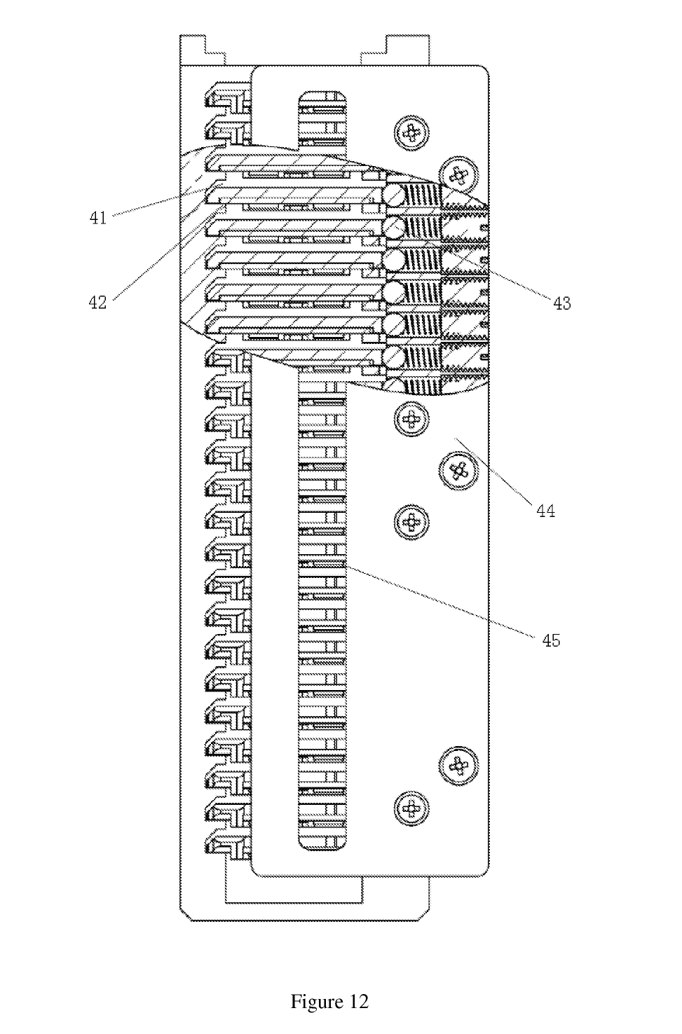

FIG. 12 shows an exemplary magazine 4 consisting of 24 compartments 41 thus can accommodate 24 slide holders 1 at one time. The compartments are arranged in a vertical column to save the space and the slide holder 1 can be inserted into or removed from the magazine 4 horizontally.

The compartments 41 are separated by guide rails 42, which can also guide and restrict the horizontal movement of the slide holders 1 into the magazine 4. The guide rail matches to the chamfer on the slide holder 1 to avoid reverse insertion. There are several positioning beads 43 installed inside the side wall of the magazine. The positioning beads 43 fit to the relieves 19 on the side of the slide holder 1 to locate and fasten the slide holder 1 and ensure the slide holder 1 with microarray slide 6 do not fall out from the magazine 4 when held in hand or loaded into the scanner. There is a back board 44 on the magazine 4 to ensure that the slide holder 1 do not slide away from the back of the magazine 4 when it is inserted with excessive strength or due to improper operations. There are rectangle openings 45 on the back board 44 to help the operator to check the slide holders inside the magazine visually from the back side. When the microarray slide 6 is placed in the slide holder 1, the user can insert the second protuberance 12′ of the slide holder first into the magazine 4 from the front side. The working surface with fluorescence labels of the microarray slide 6 always faces the ground to avoid dust contamination during loading and scanning process. On the side of the slide holder, there is a relief matching the position bead inside the side wall of the magazine.

### Example 6

### Random Access Device

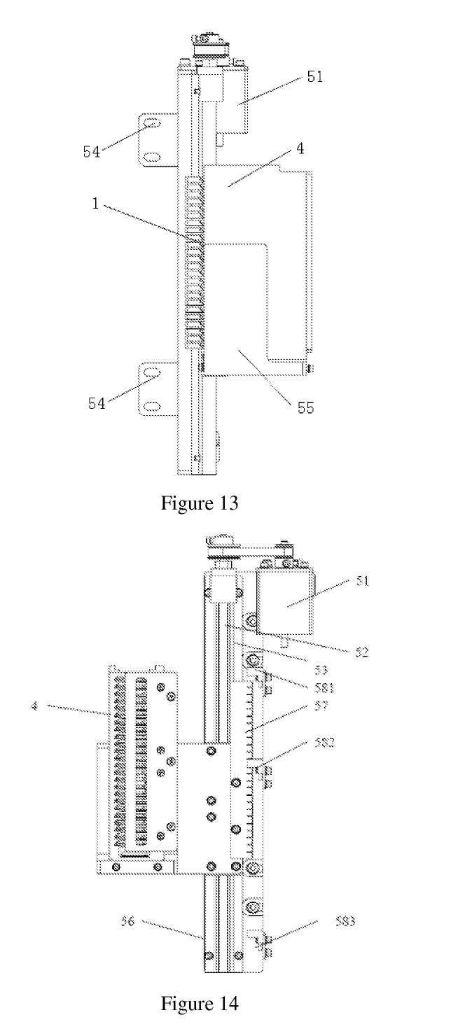

FIGS. 13 and 14 show an exemplary random access device 5 consisting of a step motor 51, a threaded rod 52, a guide rail 53, an assembly support 54, a bracket 55 and a positioning seat 56. The positioning seat 56 is fixed in the scanner via the assembly support 54. The step motor 51 and the guide rail 53 are mounted onto the positioning seat 56. The step motor 31 drives the rotation of the threaded rod 52 via a certain transmission mechanism, thus moves the slide block (not shown in the figures) on the rod 52 up and down along the guide rail 53. The bracket 55 is mounted on the slide block thus connected to the guide rail 53. The magazine can be loaded or unloaded from the bracket 55. The step motor 51 drives the rotation of the threaded rod 52, and thus the up-and-down movements of the magazine 4 and bracket 55 along the guide rail 53. There is a position detection marker 57 connected to the bracket, with the same height as the magazine 4. There are as many openings on the marker as the compartments 41 in the magazine 4. The distance between the openings is the same with the distance between the compartments 41 and there is a one-to-one relationship between the openings and the compartments 41. There are three photoelectric sensors from top to bottom in order: 581, 582 and 583 on the positioning seat 56. When the position detection marker 57 moves along with the bracket 55 up and down, the photoelectric sensor will send “ON” signal if it meets the openings on the marker 57 and will send “OFF” signal if it does not meet any of the openings. The photoelectric sensor 582 is used as closed loop feedback control to avoid misalignment of the slide holder 1 while loading and unloading. The photoelectric sensors 581 and 583 on both sides are used to define the up and down extreme positions and limit the range of the movement of the magazine.

The above examples are included for illustrative purposes only and are not intended to limit the scope of the invention. Many variations to those described above are possible. Since modifications and variations to the examples described above will be apparent to those of skill in this art, it is intended that this invention be limited only by the scope of the appended claims. All the drawings are illustrated schematically. Angles and dimensions are not to scale.

1. A slide holder comprising four surrounding protuberances to form a frame, wherein the heights of two substantially parallel protuberances (the 1^{st} protuberance and the 2^{nd} protuberance) are less than the thickness of the slide, each of the other two substantially parallel protuberances (the 3^{rd} protuberance and 4^{th} protuberance) comprises at least one hook, and the height of the hook is greater than the thickness of the slide.

2. The slide holder of claim 1, further comprising an elastic rubber column.

3. (canceled)

4. The slide holder of claim 2, wherein the elastic, rubber column comprises a body of an Fl shaped cylinder, the thinner part in the middle is used to install the elastic rubber column on the slide holder.

5-7. (canceled)

8. The slide holder of claim 1, further comprising a relief on one side of the slide holder.

9. The slide holder of claim 1, further comprising a chamfer on one edge between the side and the bottom of the slide holder.

10-13. (canceled)

14. A carrier device comprising a rod, a slide block which connects to one end of the rod, and a motor which drives the rod horizontally.

15-17. (canceled)

18. A positioning chamber comprising an installation seat with a cross section of shape, two alignment pieces symmetrically installed on the bottom of the positioning chamber, an elastic pressing sheet component in the installation seat, wherein the elastic pressing sheet component comprises one or more trolleys and a connector sheet, and each trolley is connected to the connector sheet.

19-21. (canceled)

22. An automatic slide loading device, which comprises one or more slide holders of claim 1.

23. The automatic slide loading device of claim 22, further comprising a carrier device of claim 14.

24-29. (canceled)

30. The automatic slide loading device of claim 23, further comprising a positioning chamber of claim 18.

31. The automatic slide loading device of claim 30, wherein the carrier device is mounted on the rear part of the positioning chamber.

32. (canceled)

33. The automatic slide loading device of claim 22, further comprising one or more magazines which comprise the slide holders therein.

34-37. (canceled)

38. The automatic slide loading device of claim 33, further comprising a random access device,

39-42. (canceled)

43. An automatic slide scanning device comprising an automatic slide loading device of claim 22 and a scanner which comprises a scanning platform.

44-46. (canceled)

47. A method of scanning a slide using an automatic slide scanning device of claim 43.

48-51. (canceled)

52. The method of claim 47, wherein the automatic slide scanning device comprises a magazine, and the carrier device takes the slide holder from the magazine for scanning and. returns the slide holder to the magazine after scanning.

53. The method of claim 52, wherein the automatic slide scanning device comprises a random access device, which drives the relative vertical movement between the magazine and the carrier device, and moves a pre-determined slide holder to the position of the carrier device.

54-58. (canceled)
